(19) United States
(12) Patent Application Publication
(10) Pub. No.: US 2026/0136294 A1
(43) Pub. Date: May 14, 2026

(54) TRANSMISSION PROCESSING METHOD AND APPARATUS, TERMINAL, AND NETWORK-SIDE DEVICE

(71) Applicant: VIVO MOBILE COMMUNICATION CO., LTD., Dongguan (CN)

(72) Inventor: Lihui WANG, Dongguan (CN)

(21) Appl. No.: 19/444,239

(22) Filed: Jan. 9, 2026

Related U.S. Application Data
(63) Continuation of application No. PCT/CN2024/103832, filed on Jul. 5, 2024.

(30) Foreign Application Priority Data
Jul. 10, 2023 (CN) 202310838215.X

(51) Int. Cl. H04W 52/02

(52) U.S. Cl. CPC H04W 52/0235; H04W 52/028

(57) ABSTRACT

A transmission processing method and apparatus, a terminal, and a network-side device are provided. The transmission processing method includes: performing, by a terminal, a first operation according to at least one of first information or a first condition, where the first operation includes at least one of monitoring a wake-up signal WUS or not monitoring a physical downlink control channel PDCCH; where the first condition is a condition for the terminal to enable WUS monitoring; and the first information includes at least one of the following: first indication information, where the first indication information is used for indicating activation of WUS monitoring; or second indication information, where the second indication information is used for indicating not monitoring a PDCCH.

### CROSS-REFERENCE TO RELATED APPLICATIONS

This application is a continuation of International Patent Application No. PCT/CN 2024/103832, filed on Jul. 5, 2024, which claims priority to Chinese Patent Application No. 202310838215.X filed on Jul. 10, 2023, the entire contents of which are incorporated herein by reference.

### TECHNICAL FIELD

This application pertains to the field of communication technologies and, in particular, relates to a transmission processing method and apparatus, a terminal, and a network-side device.

### BACKGROUND

With the development of communication technologies, mobile communication terminals introduce a Low Power Wake Up Radio (LP-WUR) to receive a low power signal. This allows a main communication module to remain in an off or ultra-deep sleep state, which can effectively reduce terminal power consumption. Such low power signal may also be referred to as a Low Power Wake-Up Signal (LP-WUS) or wake-up signal. However, monitoring of a WUS generally conflicts with monitoring of a Physical Downlink Control Channel (PDCCH). Therefore, after the introduction of a WUR, how to perform WUS monitoring has become an urgent problem to be solved.

### SUMMARY

Embodiments of this application provide a transmission processing method and apparatus, a terminal, and a network-side device, which can solve the problem of how to perform WUS monitoring.

In a first aspect, a transmission processing method is provided, including:
performing, by a terminal, a first operation according to at least one of first information or a first condition, where the first operation includes at least one of monitoring a wake-up signal WUS or not monitoring a physical downlink control channel PDCCH; where
the first condition is a condition for the terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

In a second aspect, a transmission processing method is provided, including:
transmitting, by a network-side device, first information to a terminal, where the first information is used for triggering the terminal to perform a first operation, and the first operation includes at least one of monitoring a wake-up signal WUS or not monitoring a physical downlink control channel PDCCH; where
the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

In a third aspect, a transmission processing apparatus is provided, including:
an execution module configured to perform a first operation according to at least one of first information or a first condition, where the first operation includes at least one of monitoring a wake-up signal WUS or not monitoring a physical downlink control channel PDCCH; where
the first condition is a condition for a terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

In a fourth aspect, a transmission processing apparatus is provided, including:
a transmitting module configured to transmit first information to a terminal, where the first information is used for triggering the terminal to perform a first operation, and the first operation includes at least one of monitoring a wake-up signal WUS or not monitoring a physical downlink control channel PDCCH; where
the first information includes at least one of the following:
first indication information, where the first indication information is used for indicating activation of WUS monitoring;
second indication information, where the second indication information is used for indicating not monitoring a PDCCH; or
third indication information, where the second indication information is used for indicating at least one of a flexible slot or a flexible symbol.

In a fifth aspect, a terminal is provided, including a processor and a memory, where the memory stores a program or an instruction executable on the processor, and the program or an instruction, when executed by the processor, implements the steps of the method according to the first aspect.

In a sixth aspect, a terminal is provided, including a processor and a communication interface, where the processor is configured to perform a first operation according to at least one of first information or a first condition, and the first operation includes at least one of monitoring a wake-up signal WUS or not monitoring a physical downlink control channel PDCCH; where

the first condition is a condition for the terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

In a seventh aspect, a network-side device is provided, where the network-side device includes a processor and a memory, the memory stores a program or an instruction executable on the processor, and the program or an instruction, when executed by the processor, implements the steps of the method according to the second aspect.

In an eighth aspect, a network-side device is provided, including a processor and a communication interface, where the processor is configured to transmit first information to a terminal, the first information is used for triggering the terminal to perform a first operation, and the first operation includes at least one of monitoring a wake-up signal WUS or not monitoring a physical downlink control channel PDCCH; where
the first information includes at least one of the following:
first indication information, where the first indication information is used for indicating activation of WUS monitoring;
second indication information, where the second indication information is used for indicating not monitoring a PDCCH; or
third indication information, where the second indication information is used for indicating at least one of a flexible slot or a flexible symbol.

In a ninth aspect, a readable storage medium is provided, where a program or an instruction is stored on the readable storage medium, and the program or an instruction, when executed by a processor, implements the steps of the method according to the first aspect or implements the steps of the method according to the second aspect.

In a tenth aspect, a wireless communication system is provided, including: a terminal and a network-side device, where the terminal can be configured to perform the steps of the method according to the first aspect, and the network-side device can be configured to perform the steps of the method according to the second aspect.

In an eleventh aspect, a chip is provided, where the chip includes a processor and a communication interface, the communication interface is coupled to the processor, and the processor is configured to run a program or an instruction to implement the method according to the first aspect or implement the method according to the second aspect.

In a twelfth aspect, a computer program/program product is provided, where the computer program/program product is stored in a storage medium, and the program/program product is executed by at least one processor to implement the method according to the first aspect or implement the method according to the second aspect.

In the embodiments of this application, the terminal performs the first operation according to at least one of the first information or the first condition, where the first operation includes at least one of monitoring a wake-up signal WUS or not monitoring a physical downlink control channel PDCCH; the first condition is a condition for the terminal to enable WUS monitoring; and the first information includes at least one of the following: the first indication information, where the first indication information is used for indicating activation of WUS monitoring; the second indication information, where the second indication information is used for indicating not monitoring a PDCCH; or the third indication information, where the third indication information is used for indicating at least one of the flexible slot or the flexible symbol. In this way, since a WUS monitoring action is clearly defined, a WUS can operate independently without relying on other power-saving mechanisms, thereby saving power consumption of the terminal.

### BRIEF DESCRIPTION OF DRAWINGS

FIG. 1 is a block diagram of a wireless communication system to which embodiments of this application can be applied;

FIG. 2 is a diagram of a terminal wake-up principle;

FIG. 3 is a schematic flowchart of a transmission processing method provided by an embodiment of this application;

FIG. 4 is a first example diagram of WUS monitoring in a transmission processing method provided by an embodiment of this application;

FIG. 5 is a second example diagram of WUS monitoring in a transmission processing method provided by an embodiment of this application;

FIG. 6 is a third example diagram of WUS monitoring in a transmission processing method provided by an embodiment of this application;

FIG. 7 is a fourth example diagram of WUS monitoring in a transmission processing method provided by an embodiment of this application;

FIG. 8 is a schematic flowchart of another transmission processing method provided by an embodiment of this application;

FIG. 9 is a schematic structural diagram of a transmission processing apparatus provided by an embodiment of this application;

FIG. 10 is a schematic structural diagram of another transmission processing apparatus provided by an embodiment of this application;

FIG. 11 is a schematic structural diagram of a communication device provided by an embodiment of this application;

FIG. 12 is a schematic structural diagram of a terminal provided by an embodiment of this application; and

FIG. 13 is a schematic structural diagram of a network-side device provided by an embodiment of this application.

### DETAILED DESCRIPTION OF EMBODIMENTS

Terms “first”, “second” and the like in this application are used to distinguish similar objects and are not used to describe a specific order or sequence. It should be understood that the terms so used are interchangeable under appropriate circumstances so that the embodiments of this application can be implemented in an order other than those illustrated or described herein, and the objects distinguished by “first” and “second” are generally of one type and the number of objects is not limited. For example, a first object may be one or may indicate more than one. In addition, “or” in this application means at least one of the connected objects. For example, “A or B” covers three cases: including A but not B; including B but not A; and including both A and B. The character “/” generally indicates an “or” relationship between the associated objects before and after the character.

The term “indicate” in this application may be a direct indication (or explicit indication) or an indirect indication (or implicit indication). A direct indication may be understood as a sender explicitly informing a receiver of specific information, an operation to be performed, a request result, and other content in a sent indication. An indirect indication may be understood as a receiver determining corresponding information according to an indication sent by a sender, or performing judgment and determining an operation to be performed, a request result, or the like according to a judgment result.

It should be noted that the technology described in the embodiments of this application is not limited to Long Term Evolution (LTE)/LTE-Advanced (LTE-A) systems, and may also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA) and other systems. The terms “system” and “network” in the embodiments of this application are often used interchangeably, and the described technologies may be used not only for the systems and radio technologies mentioned above, but also for other systems and radio technologies. The following description describes a New Radio (NR) system for exemplary purposes, and NR terminology is used in most of the following description, but these technologies may also be applied to systems other than NR systems, such as a 6^{th} Generation (6G) communication system.

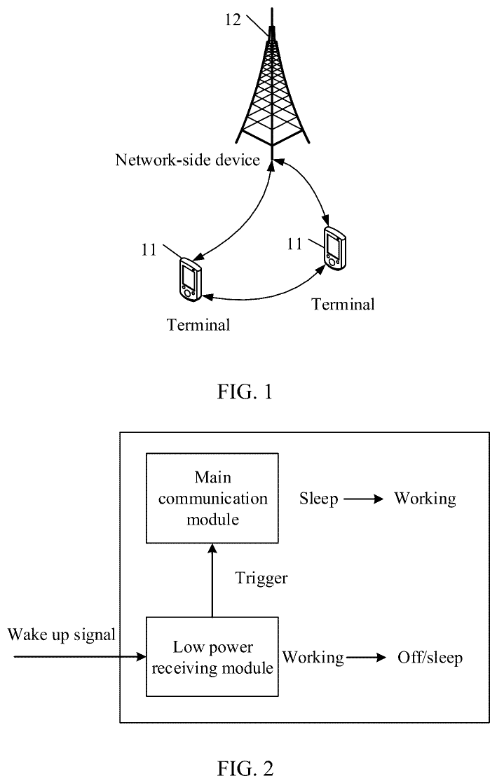

FIG. 1 is a block diagram of a wireless communication system to which embodiments of this application can be applied. The wireless communication system includes a terminal 11 and a network-side device 12. The terminal 11 may be a mobile phone, a tablet personal computer, a laptop computer, a notebook computer, a Personal Digital Assistant (PDA), a palm computer, a netbook, an Ultra-Mobile Personal Computer (UMPC), a Mobile Internet Device (MID), an Augmented Reality (AR), a Virtual Reality (VR) device, a robot, a wearable device, a flight vehicle, Vehicle User Equipment (VUE), shipboard equipment, Pedestrian User Equipment (PUE), a smart home (a home device with wireless communication function, such as a refrigerator, a television, a washing machine or furniture), a game console, a Personal Computer (PC), a teller machine, a self-service machine, or other terminal-side devices. The wearable device includes a smart watch, a smart bracelet, a smart headset, smart glasses, smart jewelry (smart bracelet, smart bangle, smart ring, smart necklace, smart anklet, or smart ankle bracelet), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that the specific type of the terminal 11 is not limited in the embodiments of this application. The network-side device 12 may include an access network device or a core network device, where the access network device may also be referred to as a Radio Access Network (RAN) device, a radio access network function or a radio access network unit. The access network device may include a base station, a Wireless Local Area Network (WLAN) Access Point (AP), a Wireless Fidelity (WiFi) node, or the like. The base station may be referred to as a Node B (NB), an Evolved Node B (eNB), a next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a Home Node B (HNB), a home evolved Node B, a Transmission Reception Point (TRP) or some other suitable term in the art. As long as the same technical effect is achieved, the base station is not limited to a specific technical term. It should be noted that in the embodiments of this application, only the base station in the NR system is taken as an example for introduction, and the specific type of the base station is not limited.

For ease of understanding, some contents involved in the embodiments of this application are described below:

### 1. Low Power Receiver

A low power receiver may be referred to as a Low Power Wake Up Radio (LP-WUR) or an Almost Zero Power Wake Up Radio (AZP-WUR). The basic working principle of an LP-WUR is that a receiving end includes a first module and a second module, the first module being a main communication module for transceiving mobile communication data, and the second module being a low power receiving module (also referred to as a low power wake-up receiving module) for receiving the low power wake-up signal, as specifically shown in FIG. 2. When the terminal is in an idle state or an inactive state, the terminal enables the low power receiving module to monitor a Low Power Wake-Up Signal (LP-WUS) in a power-saving state or an ultra-deep sleep state and disables the main communication module. When downlink data arrives, a network-side device transmits a wake-up signal to the terminal, and after the terminal detects the wake-up signal through the low power receiving module and performs a series of judgments, the main communication module is triggered to switch from off to on, while the low power receiving module switches from a working state to an off state. The low power wake-up receiving module, when enabled, can receive a low power wake-up signal.

### 2. Low Power Wake-Up Signal (LP-WUS)

In order to reduce receiving activities of a terminal in a standby state so that Radio Frequency (RF) and baseband (MODEM) modules of a receiving module of the terminal are truly disabled, thereby greatly reducing power consumption of communication reception, a near “zero” power receiver may be introduced in the receiving module of the terminal to achieve this. This near “zero” power receiver does not require complex signal detection (such as amplification, filtering, and quantization) of an RF module and signal processing of a MODEM, but only relies on passive matched filtering and signal processing with relatively low power consumption.

On the base station side, a wake-up signal is transmitted on demand (on-demand) to activate the near “zero” power receiver to obtain an activation notification, thereby triggering a series of internal processes of the terminal, such as enabling radio frequency transceiving and baseband processing modules.

Such wake-up signal is generally a relatively simple On-Off Keying (OOK) signal, so that the receiver can learn the wake-up notification through a simple energy detection process, a possible subsequent sequence detection and identification process, or the like.

Reception of a low power wake-up signal may be applied to a terminal in a Radio Resource Control (RRC) idle (RRC_idle)/inactive (inactive) state or to a terminal in an RRC connected state (RRC_connected), thereby achieving power saving of the terminal.

In one embodiment, the wake-up signal mentioned in this application is the wake-up signal received and monitored through the low power receiver, that is, the low power wake-up signal.

### 3. Connected Discontinuous Reception (C-DRX)

C-DRX may also be understood or replaced by DRX, which allows UE to periodically enter a sleep state and not monitor a Physical Downlink Control Channel (PDCCH), and to wake up from the sleep state during monitoring, thereby achieving power saving. The above-mentioned “sleep” means that the terminal does not monitor a PDCCH scrambled by a Cell Radio Network Temporary Identifier (C-RNTI), a Modulation and Coding Scheme (MCS) Cell Radio Network Temporary Identifier (MCS-C-RNTI), a Control Information RNTI (CI-RNTI), a Configured Scheduling RNTI (CS-RNTI), an Interruption RNTI (INT-RNTI), a Slot Format Indication RNTI (SFI-RNTI), a Semi-Persistent Channel State Information RNTI (SP-CSI-RNTI), a Transmit Power Control Physical Uplink Control Channel RNTI (TPC-PUCCH-RNTI), a TPC Physical Uplink Shared Channel RNTI (TPC-PUSCH-RNTI), a TPC Sounding Reference Signal RNTI (TPC-SRS-RNTI), an Availability Indicator RNTI (AI-RNTI), a Sidelink RNTI (SL-RNTI), a Sidelink Configured Scheduling RNTI (SLCS-RNTI) and an SL semi-persistent scheduling V-RNTI. Conversely, “wake up” refers to a time when the UE is “awake” for monitoring the above-mentioned PDCCH, or the like, and the awake time is collectively referred to as active time, which includes the following cases:
DRX on-duration timer (drx-onDurationTimer): the UE is monitoring whether there is a PDCCH at this time;
DRX inactivity timer (drx-InactivityTimer): the UE has detected a PDCCH and is receiving downlink data at this time;
DRX downlink retransmission timer (drx-RetransmissionTimerDL) or DRX uplink retransmission timer (drx-RetransmissionTimerUL): the UE is waiting for retransmission at this time;
Random access contention resolution timer (ra-ContentionResolutionTimer) or message B response window (msgB-ResponseWindow): the UE is waiting to receive Msg2 or Msg4 at this time;
Scheduling request is sent on PUCCH (SR is sent on PUCCH): after the UE sends a Scheduling Request (SR), the UE is waiting for an uplink grant (UL grant) at this time; and
after non-contention-based random access UE receives a Random Access Response (RAR): the UE is waiting to receive Downlink Control Information (DCI) scrambled by a C-RNTI, which is used for indicating uplink resource scheduling.

The transmission processing method provided by the embodiments of this application will be described in detail below through some embodiments and application scenarios thereof with reference to the accompanying drawings.

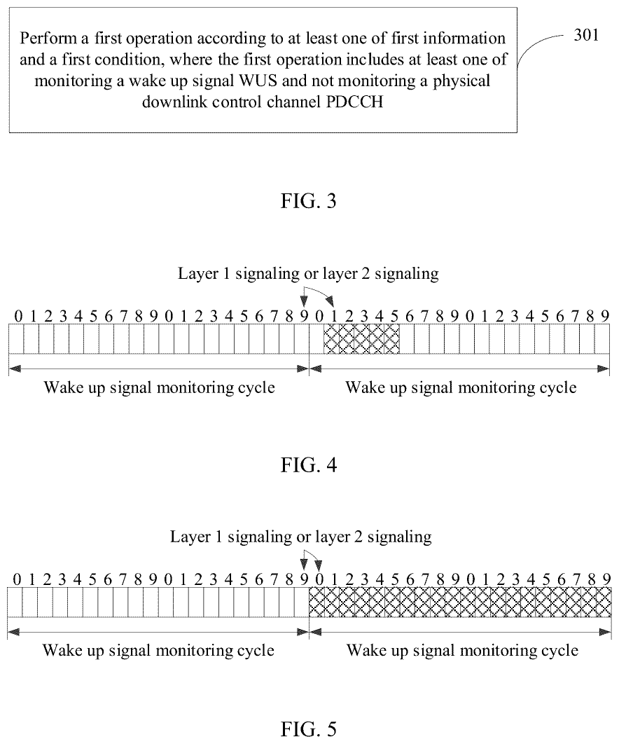

Referring to FIG. 3, an embodiment of this application provides a transmission processing method. As shown in FIG. 3, the transmission processing method includes:
Step 301: A terminal performs a first operation according to at least one of first information or a first condition, where the first operation includes at least one of monitoring a wake-up signal WUS or not monitoring a physical downlink control channel PDCCH; where
the first condition is a condition for the terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

In the embodiments of this application, the first information is information configured or indicated by a network-side device through at least one of higher-layer signaling (for example, RRC signaling), physical-layer signaling (for example, layer-1 signaling) or Medium Access Control (MAC) layer signaling (for example, layer-2 signaling).

Optionally, the first indication information may be specifically used for indicating initial (or first-time) activation or re-activation (or second-time activation) of WUS monitoring.

Optionally, the terminal performing the first operation according to the first information may be understood as the terminal performing the first operation in a case that the first information has been received. The terminal performing the first operation according to the first condition may be understood as the terminal performing the first operation in a case that the first condition being satisfied has been determined. The terminal performing the first operation according to the first information and the first condition may be understood as the terminal performing the first operation in a case that the first information has been received and the first condition being satisfied has been determined.

In the embodiments of this application, the terminal performs the first operation according to at least one of the first information or the first condition, where the first operation includes at least one of monitoring a wake-up signal WUS or not monitoring a physical downlink control channel PDCCH; the first condition is a condition for the terminal to enable WUS monitoring; and the first information includes at least one of the following: the first indication information, where the first indication information is used for indicating activation of WUS monitoring; the second indication information, where the second indication information is used for indicating not monitoring a PDCCH; or the third indication information, where the third indication information is used for indicating at least one of the flexible slot or the flexible symbol. In this way, since a WUS monitoring action is clearly defined, a WUS can operate independently without relying on other power-saving mechanisms, thereby saving power consumption of the terminal.

Optionally, in some embodiments, the first indication information includes a target parameter, where the target parameter is used for configuring or updating configuration information of a WUS, and the target parameter includes at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, where the transmission information includes at least one of whether to perform repetition or the number of repetitions.

In the embodiments of this application, in a case that the first indication information is used for indicating initial activation of WUS monitoring, the target parameter is used for configuring the configuration information of a WUS, that is, the target parameter is the configuration information of a WUS. In a case that the first indication information is used for indicating re-activation of WUS monitoring, the target parameter is used for updating the configuration information of a WUS. In this case, the target parameter is at least part of the configuration information of a WUS, and the at least part of the configuration information of a WUS currently configured for the terminal may be updated based on the target parameter.

Optionally, in a case that the target parameter includes an activation effective time of WUS monitoring and the effective time is X time units, WUS monitoring (or activation of WUS monitoring) may start at an end moment of the X-th time unit after a time unit in which the first information has been received.

Optionally, in some embodiments, the activation effective time of WUS monitoring (that is, X) is greater than or equal to at least one of the following:
a processing time of the first information;
a time for the terminal to transmit a Hybrid Automatic Repeat Request Acknowledgement (HARQ-ACK) to a network-side device for a demodulation result of the first information; or
a time for a wake-up radio of the terminal to switch from off to on.

It should be understood that a specific duration of a time unit mentioned in the embodiments of this application may be set according to actual needs. For example, it may be millisecond, slot or symbol.

Optionally, in a case that the target parameter includes a time for stopping PDCCH monitoring and the time for stopping PDCCH monitoring is Y, WUS monitoring (or activation of WUS monitoring) may start at an end moment of the Y-th time unit after a time unit in which the first information has been received.

Optionally, in some embodiments, the time for stopping PDCCH monitoring (that is, Y) is greater than or equal to at least one of the following:
a processing time of the first information; or
a time for the terminal to transmit a hybrid automatic repeat request acknowledgement HARQ-ACK to a network-side device for a demodulation result of the first information.

Optionally, the monitoring mode of the WUS may include continuous monitoring or periodic monitoring, and continuous monitoring may be understood as monitoring every M time units, where M≥1.

Optionally, the time-domain resource of the WUS may include at least one of the following:
a monitoring cycle of the WUS;
a length of a monitoring time window of the WUS in a monitoring cycle of the WUS, or a starting position of a time window in a monitoring cycle of the WUS or a detection cycle in a monitoring cycle of the WUS;
a LP-WUS monitoring position in a monitoring cycle of the WUS or in a time window in a monitoring cycle of the WUS;
a monitoring interval (interval) of the WUS in a monitoring cycle of the WUS or in a time window in a monitoring cycle of the WUS; or
a monitoring duration or continuous time in a monitoring cycle of the WUS or in a time window in a monitoring cycle of the WUS.

The frequency-domain resource of the WUS may include a starting position, a bandwidth, a guard interval, hopping information, and the like of the WUS in frequency domain.

Optionally, in some embodiments, the first condition includes at least one of the following:
a first timer expires or is terminated and a second timer is not running;
a second timer expires or is terminated;
a main communication module of the terminal is in a sleep state;
a monitoring occasion of a WUS is valid; or
no WUS is detected in a valid monitoring occasion of a WUS; where
the first timer is a timer used for limiting suspension of WUS monitoring after detection of a WUS; and the second timer is a timer used for limiting suspension of WUS monitoring after detection of a PDCCH.

In the embodiments of this application, running of the first timer and the second timer may be terminated by at least one of the following:
1. signaling termination: at least one of higher-layer signaling, physical-layer signaling or MAC-layer signaling indicates termination information; or
2. event termination: for example, occurrence of an event causing no PDCCH monitoring, such as expiration of a secondary cell deactivation timer (sCellDeactivationTimer), MAC reset (reset), expiration of a bandwidth part inactivity timer (bwp-InactivityTimer), and the like.

Optionally, a running duration of the first timer or the second timer may be configured by higher-layer signaling, or dynamically indicated by layer-1 or layer-2 signaling or a WUS signal.

Optionally, in some embodiments, the first timer may be equal to the second timer, that is, the first timer may be replaced by the second timer, or the second timer may be replaced by the first timer.

Optionally, the sleep state may include, but is not limited to, at least one of the following: deep sleep (deep sleep), light sleep (light sleep) or micro sleep (micro sleep).

Optionally, the monitoring occasion of the WUS being valid may be understood as a valid WUS monitoring occasion (valid WUS monitoring occasion, valid WUS MO).

The first operation satisfies at least one of the following:
starting WUS monitoring at a first time after the first timer expires or is terminated; or
starting WUS monitoring at a second time after the second timer expires or is terminated; where
at least one of the first time or the second time is associated with a time for a wake-up radio of the terminal to switch from off to on.

Optionally, in the embodiments of this application, a duration of the first time or the second time is defined by a protocol as a fixed value, and the fixed value is greater than or equal to 0 millisecond or 0 slot. The fixed value may be related to a Subcarrier Space (SCS) of an active BWP where the terminal is currently located.

Optionally, in some embodiments, the method further includes:
determining, by the terminal in a case that at least one of the following is satisfied, that the monitoring occasion of a WUS is valid:
no target signaling has been received after the terminal has received signaling for activating WUS monitoring;
after the terminal has received signaling for activating WUS monitoring and before received target signaling takes effect; or
the monitoring occasion of a WUS does not conflict with a transmission resource of the main communication module of the terminal, where the transmission resource includes at least one of uplink transmission, downlink reception or a guard interval; where
the target signaling is used for indicating deactivation, release or suspension of WUS monitoring.

In the embodiments of this application, the target signaling may include at least one of higher-layer signaling, physical-layer signaling or MAC-layer signaling.

Optionally, an effective time of the target signaling may be determined according to at least one of the following rules:
after a Z1-th millisecond, slot or symbol following a slot or a last symbol in which the terminal has received the target signaling, the terminal stops WUS monitoring; or
after a Z2-th millisecond, slot or symbol following a slot or a last symbol in which the terminal performs HARQ-ACK or ACK feedback for the received target signaling, the terminal stops WUS monitoring.

Optionally, existence of conflict between transmission resources may be understood or replaced by at least partial overlap of transmission resources. Conflict or overlap includes conflict or overlap in at least one of time domain, frequency domain or spatial domain.

Optionally, in some embodiments, the method further includes any one of the following:
stopping, by the terminal, WUS monitoring at a first moment after a time unit in which the terminal has received the target signaling; and
stopping, by the terminal, WUS monitoring at a third moment after a second moment; where
the second moment is a moment at which the terminal performs HARQ-ACK for the received target signaling or an end moment of a time unit in which the terminal performs HARQ-ACK for the received target signaling.

Optionally, in some embodiments, the method further includes:
performing, by the terminal, a second operation according to at least one of second information or a second condition, where the second operation includes at least one of clearing configuration information of a WUS, deactivating WUS monitoring, or monitoring a PDCCH; where
the second condition is a condition for the terminal to exit WUS monitoring; and the second information includes at least one of the following:
fourth indication information, where the fourth indication information is used for indicating at least one of deactivating WUS monitoring or clearing configuration information of a WUS;
fifth indication information, where the fifth indication information is used for indicating monitoring a PDCCH; or
sixth indication information, where the sixth indication information is used for indicating at least one of a downlink slot, a downlink symbol, an uplink slot or an uplink symbol.

In the embodiments of this application, the second information is information configured or indicated by a network-side device through at least one of higher-layer signaling (for example, RRC signaling), physical-layer signaling (for example, layer-1 signaling) or MAC-layer signaling (for example, layer-2 signaling).

Optionally, the deactivating WUS monitoring may be understood or replaced by release of WUS monitoring. The clearing configuration information of a WUS may be understood or replaced by clearing of higher-layer RRC configuration information, for example, time-domain and frequency-domain resources of the WUS.

Optionally, the terminal performing the second operation according to the second information may be understood as the terminal performing the second operation in a case that the second information has been received. The terminal performing the second operation according to the second condition may be understood as the terminal performing the second operation in a case that the second condition being satisfied has been determined. The terminal performing the second operation according to the second information and the second condition may be understood as the terminal performing the second operation in a case that the second information has been received and the second condition being satisfied has been determined.

Optionally, in some embodiments, the second condition includes at least one of the following:
a first timer is running;
a second timer is running;
a main communication module of the terminal is in a normal state;
a monitoring occasion of a WUS is invalid; or
a WUS is detected in a valid monitoring occasion of a WUS; where
the first timer is a timer used for limiting suspension of WUS monitoring after detection of a WUS; and the second timer is a timer used for limiting suspension of WUS monitoring after detection of a PDCCH.

Optionally, in some embodiments, the method further includes:
in a case that a WUS is detected, starting, by the terminal, the first timer at a third time after a time unit in which the WUS is detected.

For example, when a low power receiving module of the terminal detects a WUS in a Monitoring Occasion (MO), the terminal starts and runs the first timer at the third time following a slot/symbol in which the WUS is detected, and during running of the first timer, the terminal monitors a PDCCH and does not monitor the WUS.

Optionally, in some embodiments, the method further includes at least one of the following:
in a case that a PDCCH is detected during running of the first timer, starting, by the terminal, a second timer at a fourth time after an end moment of a time unit in which the detected PDCCH is located; or
in a case that a PDCCH is detected during running of the second timer, restarting, by the terminal, the second timer.

Optionally, at least one of the third time or the fourth time is associated with a capability of a time for a wake-up radio of the terminal to switch from on to off. In some embodiments, a duration of the third time or the fourth time is defined by a protocol as a fixed value, and the fixed value is greater than or equal to 0 millisecond or 0 slot. The fixed value may be related to a SCS of an active BWP where the terminal is currently located.

Optionally, the main communication module of the terminal being in a normal state may be understood or replaced by the main communication module of the terminal not being in a sleep state or the main communication module of the terminal being in a wake-up state. The main communication module of the terminal not being in a sleep state includes at least one sleep state of not being in one of deep sleep, light sleep or micro sleep. In the embodiments of this application, the normal receiving state may be understood as the terminal being able to perform an action in an RRC_IDLE or RRC_INACTIVE state, including receiving paging, measurement and evaluation related to cell selection or reselection based on a Synchronization Signal and PBCH Block (SSB), Public Land Mobile Network (PLMN) selection, receiving system information, and the like.

Optionally, in some embodiments, the second operation satisfies:
in a case that a WUS is detected in the valid monitoring occasion of a WUS, the terminal starts PDCCH monitoring from an N-th time unit after a time unit in which the WUS is detected.

In the embodiments of this application, granularity of the time unit may be millisecond, slot or symbol.

Optionally, a value of N may be agreed by a protocol, configured by RRC or indicated in a detected WUS. The value of N is greater than or equal to (or no less than) at least one of: a WUS processing time, a time required for waking up the main communication module of the terminal, or a time required for preparing to monitor a PDCCH.

Optionally, in some embodiments, in a case that the WUS belongs to at least two WUS repetitions, the time unit in which the WUS is detected includes any one of the following:
a time unit in which the WUS is detected at any time;
a first time unit of repetition of the WUS; and
a last time unit of repetition of the WUS.

Optionally, in some embodiments, the method further includes:
determining, by the terminal in a case that at least one of the following is satisfied, that the monitoring occasion of a WUS is invalid:
the terminal has received signaling for deactivating WUS monitoring and the signaling for deactivating WUS monitoring takes effect; or
the monitoring occasion of a WUS conflicts with a transmission resource of the main communication module of the terminal, where the transmission resource includes at least one of uplink transmission, downlink reception or a guard interval.

For better understanding of this application, detailed description is given below through some examples.

In some embodiments, time-domain information and frequency-domain information of WUS monitoring may be configured by RRC signaling such as RRC signaling. The time-domain information of the WUS includes at least a monitoring cycle of the WUS, a WUS monitoring window in the monitoring cycle and a monitoring position (continuous monitoring or discrete monitoring) in the monitoring window. The frequency-domain information of the WUS includes at least a size of an occupied frequency-domain resource.

Activation signaling and deactivation signaling (or release signaling) of WUS monitoring may be dynamically indicated by layer-1 or layer-2 information, and the layer-1 or layer-2 information includes at least: activation of WUS monitoring or deactivation of WUS monitoring.

Optionally, when the layer-1 or layer-2 information indicates activation of WUS monitoring, a starting position of a monitoring cycle of a WUS, a starting position of a WUS monitoring window in a monitoring cycle, a monitoring position of a WUS in a monitoring window, and a starting position of a WUS in frequency domain may also be indicated.

Optionally, in a case that the terminal has multiple configurations of WUS (that is, multiple WUS configurations, different LP-WUS configurations being represented by different indices (index)), the activation and deactivation information may further indicate which WUS configuration is activated or deactivated by the current layer-1 or layer-2 information. That is, the layer-1 or layer-2 information indicates a WUS configuration index to be activated or deactivated.

As shown in FIG. 4, in some embodiments, RRC signaling configures a monitoring cycle of a WUS to be 20 slots and a WUS monitoring window to be 5 slots. Assuming that layer-1 or layer-2 signaling activates WUS monitoring and indicates that a starting position of a WUS monitoring window is slot 1, WUS monitoring will be performed from slot 1 to slot 5.

As shown in FIG. 5, in some embodiments, RRC signaling configures a monitoring cycle of a WUS to be 20 slots and a WUS monitoring window to be 20 slots (that is, continuous monitoring). Assuming that layer-1 or layer-2 signaling activates WUS monitoring and indicates that a starting position of a WUS monitoring window is slot 0, WUS monitoring will be performed in a continuous monitoring manner after slot 0.

As shown in FIG. 6, in some embodiments, RRC signaling configures a monitoring cycle of a WUS to be 20 slots and a WUS monitoring window to be 10 slots, and MOs in the monitoring window are mapped to 10 slots of the monitoring window in the form of a 10-bit bitmap (bitmap), which are configured as (0,0,1,0,1,0,1,1,1,1). From left to right, the leftmost bit represents the 10th slot, and so on, and the rightmost bit represents the 1st slot, where a bit set to 1 indicates presence of a WUS MO and a bit set to 0 indicates absence of a WUS MO.

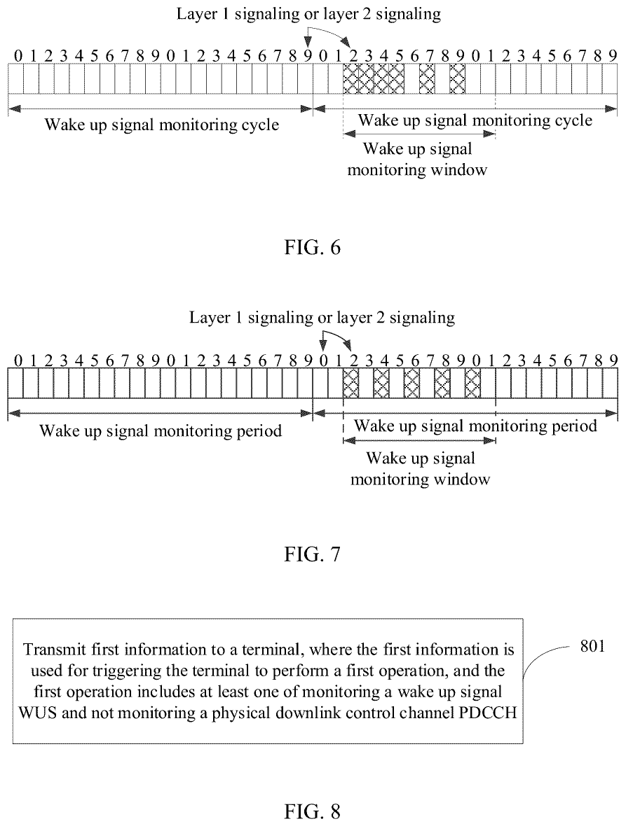

As shown in FIG. 7, in some embodiments, RRC signaling configures a monitoring cycle of a WUS to be 20 slots and a WUS monitoring window to be 10 slots, and an MO period or interval in the monitoring window is 2 slots.

In some embodiments, in a case that the terminal receives, in slot (slot) n, layer-1 or layer-2 signaling for activating WUS monitoring, in slot n+X, the terminal stops PDCCH monitoring and starts LP-WUS monitoring in slot n+Y, where X is less than or equal to Y, and X and Y may be indicated by the layer-1 or layer-2 signaling or determined by a protocol or RRC configuration. The following cases are assumed:
A. a time required by the terminal to demodulate the first information is 1 slot;
B. a time for a WUR to start WUS monitoring is 0.5 slot; and
C. a HARQ-ACK needs to be fed back for demodulation of the first information.

In this case, assuming that the terminal feeds back a HARQ-ACK in slot n+2, a value of X at least needs to be greater than or equal to A, C or max(A, C); and a value of Y at least needs to be greater than or equal to A, B, C, max(A, B) or max(A, B, C).

Optionally, once the terminal detects a WUS in slot n+j, the terminal should start PDCCH monitoring in slot n+j+2, where 2 slots are greater than or equal to a time required by the terminal to process a WUS, a time required to wake up the main communication module, or a time required to prepare to start PDCCH monitoring. Until the terminal has received again layer-1 or layer-2 signaling for re-activating WUS monitoring, the terminal resumes or re-activates WUS monitoring and does not monitor a PDCCH (or stops PDCCH monitoring).

Optionally, the layer-1 signaling may be related Downlink Control Information (DCI) carrying PDCCH skipping (skipping) signaling.

In a case that the DCI indicates enabling PDCCH skipping, WUS monitoring is activated and WUS monitoring is performed during a PDCCH skipping time; and
in a case that the DCI indicates not enabling PDCCH skipping, WUS monitoring is deactivated and WUS monitoring does not need to be performed during a PDCCH skipping time.

Optionally, activation of WUS monitoring is related to a PDCCH skipping duration (duration). In a case that the DCI indicates enabling of PDCCH skipping and the PDCCH skipping duration is greater than a certain time, WUS monitoring is activated. Otherwise, WUS monitoring is deactivated and WUS monitoring does not need to be performed during a PDCCH skipping time.

Optionally, the layer-1 signaling may be related DCI carrying signaling that indicates a slot format (slot format), such as DCI format 2_0. For example, on a flexible (flexible) symbol or slot indicated by the DCI, the terminal performs WUS monitoring.

Optionally, once the terminal detects a WUS in slot n+j, the UE starts the first timer in slot n+j (current slot) or n+j+1 (next slot after the WUS is detected) or n+j+2 (same slot as a slot in which PDCCH monitoring starts), and the terminal starts PDCCH monitoring in slot n+j+2, where 2 slots are greater than or equal to a time required by the terminal to process a WUS, a time required to wake up the main communication module or a time required to prepare to start PDCCH monitoring.

Optionally, during running of the first timer, if the terminal detects a PDCCH, the terminal starts the second timer.

During running of the second timer, if the terminal detects a PDCCH, the terminal restarts the second timer. If the terminal has not detected any PDCCH and the second timer expires or if the terminal has received signaling for stopping running of the second timer, the terminal resumes or re-activates WUS monitoring and does not perform PDCCH monitoring.

Optionally, during running of the first timer, if the terminal has not detected any PDCCH and the first timer expires or if the terminal has received signaling for stopping running of the first timer, the terminal resumes or re-activates WUS monitoring and does not perform PDCCH monitoring.

Referring to FIG. 8, an embodiment of this application further provides a transmission processing method. As shown in FIG. 8, the transmission processing method includes:

Step 801: A network-side device transmits first information to a terminal, where the first information is used for triggering the terminal to perform a first operation, and the first operation includes at least one of monitoring a wake-up signal WUS or not monitoring a physical downlink control channel PDCCH; where
the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

Optionally, the first indication information includes a target parameter, where the target parameter is used for configuring or updating configuration information of a WUS, and the target parameter includes at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, where the transmission information includes at least one of whether to perform repetition or the number of repetitions.

Optionally, the activation effective time of WUS monitoring is greater than or equal to at least one of the following:
a processing time of the first information;
a time for the terminal to transmit a hybrid automatic repeat request acknowledgement HARQ-ACK to the network-side device for a demodulation result of the first information; or
a time for a wake-up radio of the terminal to switch from off to on.

Optionally, the time for stopping PDCCH monitoring is greater than or equal to at least one of the following:
a processing time of the first information; or
a time for the terminal to transmit a hybrid automatic repeat request acknowledgement HARQ-ACK to the network-side device for a demodulation result of the first information.

Optionally, after the transmitting, by a network-side device, first information to a terminal, the method further includes:
transmitting, by the network-side device, second information to the terminal, where the second information includes at least one of the following:
fourth indication information, where the fourth indication information is used for indicating at least one of deactivating WUS monitoring or clearing configuration information of a WUS;
fifth indication information, where the fifth indication information is used for indicating monitoring a PDCCH; or
sixth indication information, where the sixth indication information is used for indicating at least one of a downlink slot, a downlink symbol, an uplink slot or an uplink symbol.

The transmission processing method provided by the embodiments of this application may be executed by a transmission processing apparatus. In the embodiments of this application, the transmission processing apparatus executing the transmission processing method is taken as an example to describe the transmission processing apparatus provided by the embodiments of this application.

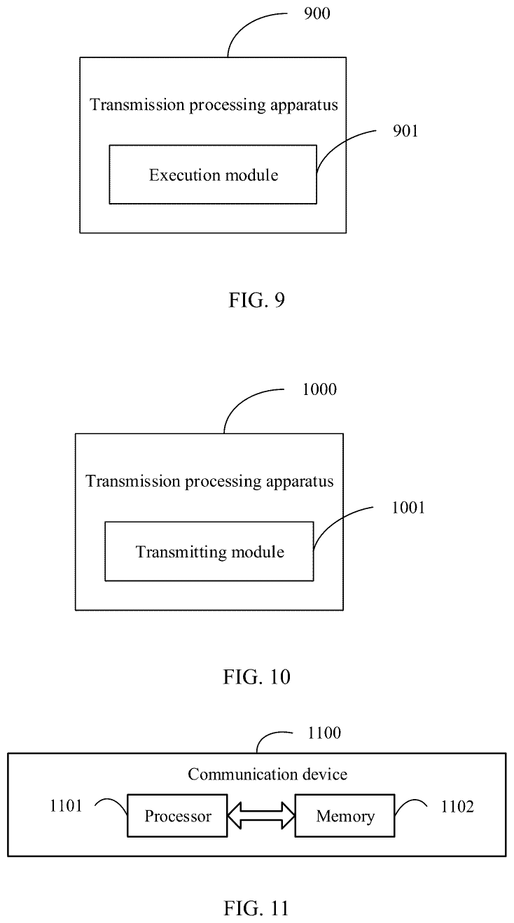

Referring to FIG. 9, an embodiment of this application further provides a transmission processing apparatus. As shown in FIG. 9, the transmission processing apparatus 900 includes:
an execution module 901 configured to perform a first operation according to at least one of first information or a first condition, where the first operation includes at least one of monitoring a wake-up signal WUS or not monitoring a physical downlink control channel PDCCH; where
the first condition is a condition for a terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

Optionally, the first indication information includes a target parameter, where the target parameter is used for configuring or updating configuration information of a WUS, and the target parameter includes at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, where the transmission information includes at least one of whether to perform repetition or the number of repetitions.

Optionally, the activation effective time of WUS monitoring is greater than or equal to at least one of the following:
a processing time of the first information;
a time for the terminal to transmit a hybrid automatic repeat request acknowledgement HARQ-ACK to a network-side device for a demodulation result of the first information; or
a time for a wake-up radio of the terminal to switch from off to on.

Optionally, the time for stopping PDCCH monitoring is greater than or equal to at least one of the following:
a processing time of the first information; or
a time for the terminal to transmit a hybrid automatic repeat request acknowledgement HARQ-ACK to a network-side device for a demodulation result of the first information.

Optionally, the first condition includes at least one of the following:
a first timer expires or is terminated and a second timer is not running;
a second timer expires or is terminated;
a main communication module of the terminal is in a sleep state;
a monitoring occasion of a WUS is valid; or
no WUS is detected in a valid monitoring occasion of the WUS; where
the first timer is a timer used for limiting suspension of WUS monitoring after detection of a WUS; and the second timer is a timer used for limiting suspension of WUS monitoring after detection of a PDCCH.

Optionally, the first operation satisfies at least one of the following:
starting WUS monitoring at a first time after the first timer expires or is terminated; or
starting WUS monitoring at a second time after the second timer expires or is terminated; where
at least one of the first time or the second time is associated with a time for a wake-up radio of the terminal to switch from off to on.

Optionally, the transmission processing apparatus 900 further includes:
a determining module configured to, in a case that at least one of the following is satisfied, determine that the monitoring occasion of a WUS is valid:
no target signaling has been received after the terminal has received signaling for activating WUS monitoring;
after the terminal has received signaling for activating WUS monitoring and before received target signaling takes effect; or
the monitoring occasion of a WUS does not conflict with a transmission resource of the main communication module of the terminal, where the transmission resource includes at least one of uplink transmission, downlink reception or a guard interval; where
the target signaling is used for indicating deactivation, release or suspension of WUS monitoring.

Optionally, the execution module 901 is further configured to perform any one of the following:
stopping WUS monitoring at a first moment after a time unit in which the terminal has received the target signaling; and
stopping WUS monitoring at a third moment after a second moment; where
the second moment is a moment at which the terminal performs HARQ-ACK for the received target signaling or an end moment of a time unit in which the terminal performs HARQ-ACK for the received target signaling.

Optionally, the execution module 901 is further configured to perform a second operation according to at least one of second information or a second condition, where the second operation includes at least one of clearing configuration information of a WUS, deactivating WUS monitoring, or monitoring a PDCCH; where
the second condition is a condition for the terminal to exit WUS monitoring; and the second information includes at least one of the following:
fourth indication information, where the fourth indication information is used for indicating at least one of deactivating WUS monitoring or clearing configuration information of a WUS;
fifth indication information, where the fifth indication information is used for indicating monitoring a PDCCH; or
sixth indication information, where the sixth indication information is used for indicating at least one of a downlink slot, a downlink symbol, an uplink slot or an uplink symbol.

Optionally, the second condition includes at least one of the following:
a first timer is running;
a second timer is running;
a main communication module of the terminal is in a normal state;
a monitoring occasion of a WUS is invalid; or
a WUS is detected in a valid monitoring occasion of a WUS; where
the first timer is a timer used for limiting suspension of WUS monitoring after detection of a WUS; and the second timer is a timer used for limiting suspension of WUS monitoring after detection of a PDCCH.

Optionally, the execution module 901 is further configured to, in a case that a WUS is detected, start the first timer at a third time after a time unit in which the WUS is detected.

Optionally, the execution module 901 is further configured to perform at least one of the following:
in a case that a PDCCH is detected during running of the first timer, starting a second timer at a fourth time after an end moment of a time unit in which the detected PDCCH is located; or
in a case that a PDCCH is detected during running of the second timer, restarting the second timer.

Optionally, the second operation satisfies:
in a case that a WUS is detected in the valid monitoring occasion of a WUS, the terminal starts PDCCH monitoring from an N-th time unit after a time unit in which the WUS is detected.

Optionally, in a case that the WUS belongs to at least two WUS repetitions, the time unit in which the WUS is detected includes any one of the following:
a time unit in which the WUS is detected at any time;
a first time unit of repetition of the WUS; and
a last time unit of repetition of the WUS.

Optionally, the transmission processing apparatus 900 further includes:
a determining module configured to, in a case that at least one of the following is satisfied, determine that the monitoring occasion of a WUS is invalid:
the terminal has received signaling for deactivating WUS monitoring and the signaling for deactivating WUS monitoring takes effect; or
the monitoring occasion of a WUS conflicts with a transmission resource of the main communication module of the terminal, where the transmission resource includes at least one of uplink transmission, downlink reception or a guard interval.

Referring to FIG. 10, an embodiment of this application further provides a transmission processing apparatus. As shown in FIG. 10, the transmission processing apparatus 1000 includes:
a transmitting module 1001 configured to transmit first information to a terminal, where the first information is used for triggering the terminal to perform a first operation, and the first operation includes at least one of monitoring a wake-up signal WUS or not monitoring a physical downlink control channel PDCCH; where
the first information includes at least one of the following:
first indication information, where the first indication information is used for indicating activation of WUS monitoring;
second indication information, where the second indication information is used for indicating not monitoring a PDCCH; or
third indication information, where the second indication information is used for indicating at least one of a flexible slot or a flexible symbol.

Optionally, the first indication information includes a target parameter, where the target parameter is used for configuring or updating configuration information of a WUS, and the target parameter includes at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, where the transmission information includes at least one of whether to perform repetition or the number of repetitions.

Optionally, the activation effective time of WUS monitoring is greater than or equal to at least one of the following:
a processing time of the first information;
a time for the terminal to transmit a hybrid automatic repeat request acknowledgement HARQ-ACK to a network-side device for a demodulation result of the first information; or
a time for a wake-up radio of the terminal to switch from off to on.

Optionally, the time for stopping PDCCH monitoring is greater than or equal to at least one of the following:
a processing time of the first information; or
a time for the terminal to transmit a hybrid automatic repeat request acknowledgement HARQ-ACK to a network-side device for a demodulation result of the first information.

Optionally, the transmitting module 1001 is further configured to transmit second information to the terminal, where the second information includes at least one of the following:
fourth indication information, where the fourth indication information is used for indicating at least one of deactivating WUS monitoring or clearing configuration information of a WUS;
fifth indication information, where the fifth indication information is used for indicating monitoring a PDCCH; or
sixth indication information, where the sixth indication information is used for indicating at least one of a downlink slot, a downlink symbol, an uplink slot or an uplink symbol.

The transmission processing apparatus in the embodiments of this application may be an electronic device, for example, an electronic device with an operating system, or may be a component in an electronic device, for example, an integrated circuit or a chip. The electronic device may be a terminal or other devices than a terminal. For example, the terminal may include but is not limited to the types of the terminal 11 listed above, and other devices may be a server, a Network Attached Storage (NAS), or the like, which are not specifically limited in the embodiments of this application.

The transmission processing apparatus provided by the embodiments of this application can implement the processes implemented in the method embodiments of FIG. 3 to FIG. 8 and achieve the same technical effects. To avoid repetition, details are not repeated herein.

As shown in FIG. 11, an embodiment of this application further provides a communication device 1100, including a processor 1101 and a memory 1102, where the memory 1102 stores a program or an instruction executable on the processor 1101, and the program or an instruction, when executed by the processor 1101, implements the steps of the above transmission processing method embodiments and can achieve the same technical effects. To avoid repetition, details are not repeated herein.

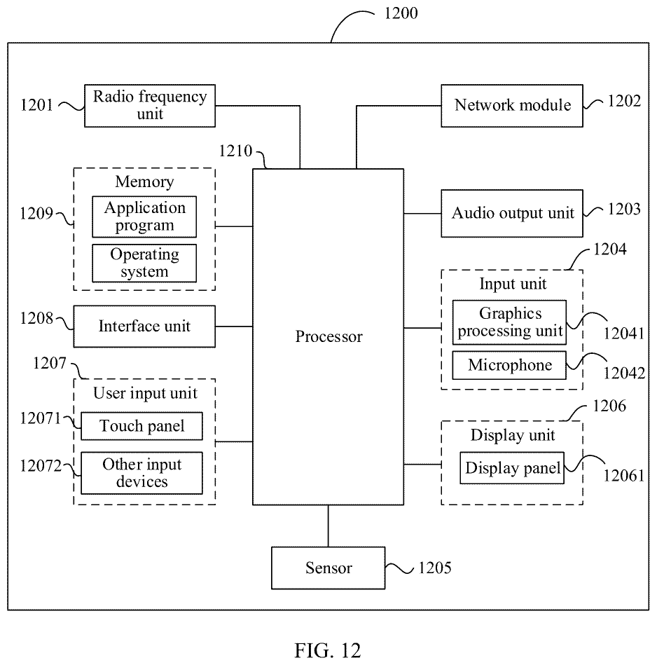

An embodiment of this application further provides a terminal, including a processor and a communication interface, where the communication interface is coupled to the processor, and the processor is configured to run a program or an instruction to implement the steps of the method embodiment as shown in FIG. 3. The terminal embodiment corresponds to the above terminal-side method embodiment, and each implementation process and implementation manner of the above method embodiment can be applied to the terminal embodiment and can achieve the same technical effects. Specifically, FIG. 12 is a schematic diagram of a hardware structure of a terminal for implementing an embodiment of this application.

The terminal 1200 includes but is not limited to at least part of components such as a radio frequency unit 1201, a network module 1202, an audio output unit 1203, an input unit 1204, a sensor 1205, a display unit 1206, a user input unit 1207, an interface unit 1208, a memory 1209 and a processor 1210.

Those skilled in the art can understand that the terminal 1200 may further include a power supply (such as a battery) for supplying power to various components, and the power supply may be logically connected to the processor 1210 via a power management system, thereby realizing functions such as charging management, discharging management and power consumption management via the power management system. The terminal structure shown in FIG. 12 does not constitute a limitation on the terminal, and the terminal may include more or fewer components than those shown in the figure, or combine some components, or have different component arrangements, which will not be described in detail herein.

It should be understood that in the embodiments of this application, the input unit 1204 may include a Graphics Processing Unit (GPU) 12041 and a microphone 12042, and the graphics processor 12041 processes image data of static pictures or videos obtained by an image capture device (such as a camera) in a video capture mode or an image capture mode. The display unit 1206 may include a display panel 12061, which may be configured in the form of a liquid crystal display, an organic light emitting diode, etc. The user input unit 1207 includes at least one of a touch panel 12071 or other input devices 12072. The touch panel 12071 is also referred to as a touch screen. The touch panel 12071 may include two parts: a touch detection device and a touch controller. The other input devices 12072 may include but are not limited to a physical keyboard, function keys (such as a volume control key and a switch key), a trackball, a mouse and a joystick, which will not be repeated herein.

In this embodiment of this application, the radio frequency unit 1201, after receiving downlink data from a network-side device, may transmit it to the processor 1210 for processing. In addition, the radio frequency unit 1201 may transmit uplink data to the network-side device. Generally, the radio frequency unit 1201 includes but is not limited to an antenna, an amplifier, a transceiver, a coupler, a low noise amplifier, a duplexer, and the like.

The memory 1209 may be configured to store software programs or instructions and various data. The memory 1209 may mainly include a first storage area for storing programs or instructions and a second storage area for storing data. The first storage area may store an operating system, an application program or an instruction required by at least one function (such as a sound playback function and an image playback function), and the like. In addition, the memory 1209 may include a volatile memory or a non-volatile memory. The non-volatile memory may be a Read-Only Memory (ROM), a Programmable Read-Only Memory (Programmable ROM, PROM), an Erasable Programmable Read-Only Memory (Erasable PROM, EPROM), an Electrically Erasable Programmable Read-Only Memory (Electrically EPROM, EEPROM) or a flash memory. The volatile memory may be a Random Access Memory (RAM), a Static Random Access Memory (Static RAM, SRAM), a Dynamic Random Access Memory (Dynamic RAM, DRAM), a Synchronous Dynamic Random Access Memory (Synchronous DRAM, SDRAM), a Double Data Rate Synchronous Dynamic Random Access Memory (Double Data Rate SDRAM, DDRSDRAM), an Enhanced Synchronous Dynamic Random Access Memory (Enhanced SDRAM, ESDRAM), a Synch Link Dynamic Random Access Memory (Synch link DRAM, SLDRAM) and a Direct Rambus Random Access Memory (Direct Rambus RAM, DRRAM). The memory 1209 in the embodiments of this application includes but is not limited to these and any other suitable types of memory.

The processor 1210 may include one or more processing units. Optionally, the processor 1210 integrates an application processor and a modem processor, where the application processor mainly processes operations involving an operating system, a user interface, an application program, and the like, and the modem processor mainly processes wireless communication signals, such as a baseband processor. It can be understood that the above modem processor may not be integrated into the processor 1210.

The processor 1210 is configured to perform a first operation according to at least one of first information or a first condition, where the first operation includes at least one of monitoring a wake-up signal WUS or not monitoring a physical downlink control channel PDCCH; where
the first condition is a condition for the terminal to enable WUS monitoring; and the first information includes at least one of the following:
first indication information, where the first indication information is used for indicating activation of WUS monitoring;
second indication information, where the second indication information is used for indicating not monitoring a PDCCH; or
third indication information, where the third indication information is used for indicating at least one of a flexible slot or a flexible symbol.

It can be understood that for the implementation processes of the implementation manners mentioned in this embodiment, reference can be made to the relevant description in the method embodiments and achieve the same or corresponding technical effects. To avoid repetition, details are not repeated herein.

An embodiment of this application further provides a network-side device, including a processor and a communication interface, where the communication interface is coupled to the processor, and the processor is configured to run a program or an instruction to implement the steps of the method embodiment as shown in FIG. 8. The network-side device embodiment corresponds to the above network-side device method embodiment, and each implementation process and implementation manner of the above method embodiment can be applied to the network-side device embodiment and can achieve the same technical effects.

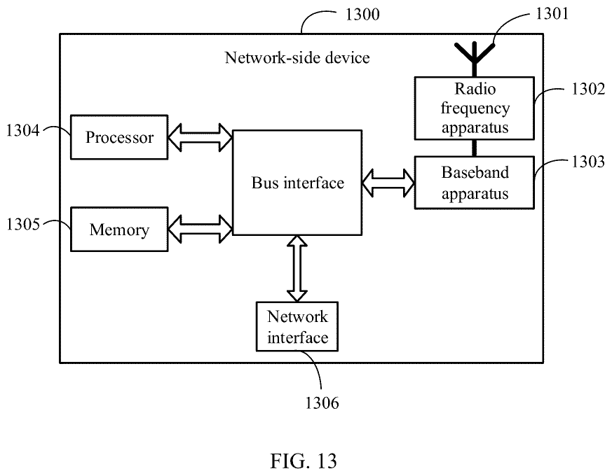

Specifically, an embodiment of this application further provides a network-side device. As shown in FIG. 13, the network-side device 1300 includes an antenna 131, a radio frequency apparatus 132, a baseband apparatus 133, a processor 134 and a memory 135. The antenna 131 is connected to the radio frequency apparatus 132. In uplink, the radio frequency apparatus 132 receives information via the antenna 131 and transmits the received information to the baseband apparatus 133 for processing. In downlink, the baseband apparatus 133 processes information to be transmitted and transmits it to the radio frequency apparatus 132, and the radio frequency apparatus 132 processes the received information and then transmits it via the antenna 131.

The method performed by the network-side device in the above embodiments may be implemented in the baseband apparatus 133, and the baseband apparatus 133 includes a baseband processor.

The baseband apparatus 133 may, for example, include at least one baseband board, and the baseband board is provided with a plurality of chips. As shown in FIG. 13, one of the chips is, for example, a baseband processor, and is connected to the memory 135 via a bus interface to call a program in the memory 135 and execute the operations of the network device shown in the above method embodiments.

The network-side device may further include a network interface 136, and the interface is such as a Common Public Radio Interface (CPRI).

Specifically, the network-side device 1300 of this embodiment of this application further includes an instruction or a program stored in the memory 135 and executable on the processor 134, and the processor 134 calls the instruction or program in the memory 135 to execute the method executed by the modules shown in FIG. 10 and achieve the same technical effects. To avoid repetition, details are not repeated herein.

An embodiment of this application further provides a readable storage medium, where a program or an instruction is stored on the readable storage medium, and the program or an instruction, when executed by a processor, implements the processes of the above transmission processing method embodiments and can achieve the same technical effects. To avoid repetition, details are not repeated herein.

The processor is the processor in the terminal described in the above embodiments. The readable storage medium includes a computer-readable storage medium, such as a computer read-only memory ROM, a random access memory RAM, a magnetic disk or an optical disk. In some examples, the readable storage medium may be a non-transitory readable storage medium.

An embodiment of this application further provides a chip, and the chip includes a processor and a communication interface. The communication interface is coupled to the processor, and the processor is configured to run a program or an instruction to implement the processes of the above transmission processing method embodiments and can achieve the same technical effects. To avoid repetition, details are not repeated herein.

It should be understood that the chip mentioned in the embodiments of this application may also be referred to as a system-level chip, a system chip, a chip system, or a system-on-chip chip.

An embodiment of this application further provides a computer program/program product, where the computer program/program product is stored in a storage medium, and the computer program/program product is executed by at least one processor to implement the processes of the above transmission processing method embodiments and can achieve the same technical effects. To avoid repetition, details are not repeated herein.

An embodiment of this application further provides a wireless communication system, including a terminal and a network-side device, where the terminal can be configured to perform the steps of the transmission processing method on the terminal side as described above, and the network-side device can be used for performing the steps of the transmission processing method on the network-side device as described above.

It should be noted that in this specification, the terms “include”, “comprise” or any other variants thereof are intended to cover non-exclusive inclusion, so that a process, method, article or apparatus including a series of elements not only includes those elements, but also includes other elements not explicitly listed, or also includes elements inherent to such process, method, article or apparatus. Without more limitations, an element defined by the statement “including one . . . ” does not exclude the existence of another identical element in the process, method, article or apparatus including the element. In addition, it should be noted that the scope of the methods and apparatuses in the embodiments of this application is not limited to performing functions in the order shown or discussed, and may further include performing functions in a substantially simultaneous manner or in a reverse order according to the functions involved. For example, the described methods may be performed in an order different from the described order, and various steps may also be added, omitted or combined. In addition, features described with reference to some examples may be combined in other examples.

From the above description of the embodiments, those skilled in the art can clearly understand that the methods in the above embodiments can be implemented by means of software plus a necessary general hardware platform, and of course, can also be implemented by hardware. The computer software product is stored in a storage medium (such as a ROM, a RAM, a magnetic disk or an optical disk) and includes several instructions to cause a terminal or a network-side device to execute the methods described in the embodiments of this application.

The embodiments of this application have been described above with reference to the accompanying drawings, but this application is not limited to the above specific embodiments. The above specific embodiments are merely illustrative rather than restrictive. Many forms of embodiments can be made by those of ordinary skill in the art under the enlightenment of this application without departing from the purpose of this application and the scope protected by the claims, all of which fall within the protection of this application.

What is claimed is:

1. A transmission processing method, comprising:
performing, by a terminal, a first operation according to at least one of first information or a first condition, wherein the first operation comprises at least one of monitoring a wake-up signal (WUS) or not monitoring a physical downlink control channel (PDCCH); wherein
the first condition is a condition for the terminal to enable WUS monitoring; and the first information comprises at least one of the following:
first indication information, wherein the first indication information is used for indicating activation of WUS monitoring; or
second indication information, wherein the second indication information is used for indicating not monitoring a PDCCH.

2. The method according to claim 1, wherein the first indication information comprises a target parameter, wherein the target parameter is used for configuring or updating configuration information of a WUS, and the target parameter comprises at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, wherein the transmission information comprises at least one of whether to perform repetition or the number of repetitions.

3. The method according to claim 2, wherein the activation effective time of WUS monitoring is greater than or equal to at least one of the following:
a processing time of the first information;
a time for the terminal to transmit a hybrid automatic repeat request acknowledgement HARQ-ACK to a network-side device for a demodulation result of the first information; or
a time for a wake-up radio of the terminal to switch from off to on.

4. The method according to claim 1, wherein the first condition comprises at least one of the following:
a first timer expires or is terminated and a second timer is not running;
a second timer expires or is terminated;
a main communication module of the terminal is in a sleep state;
a monitoring occasion of a WUS is valid; or
no WUS is detected in a valid monitoring occasion of a WUS; wherein
the first timer is a timer used for limiting suspension of WUS monitoring after detection of a WUS; and the second timer is a timer used for limiting suspension of WUS monitoring after detection of a PDCCH.

5. The method according to claim 4, wherein the first operation satisfies at least one of the following:
starting WUS monitoring at a first time after the first timer expires or is terminated; or
starting WUS monitoring at a second time after the second timer expires or is terminated; wherein
at least one of the first time or the second time is associated with a time for a wake-up radio of the terminal to switch from off to on.

6. The method according to claim 4, wherein the method further comprises:
determining, by the terminal in a case that the following is satisfied, that the monitoring occasion of a WUS is valid:
the monitoring occasion of a WUS does not conflict with a transmission resource of the main communication module of the terminal, wherein the transmission resource comprises at least one of uplink transmission, downlink reception or a guard interval.

7. The method according to claim 1, wherein the method further comprises:
performing, by the terminal, a second operation according to at least one of second information or a second condition, wherein the second operation comprises at least one of clearing configuration information of a WUS, deactivating WUS monitoring, or monitoring a PDCCH; wherein
the second condition is a condition for the terminal to exit WUS monitoring; and the second information comprises at least one of the following:
fourth indication information, wherein the fourth indication information is used for indicating at least one of deactivating WUS monitoring or clearing configuration information of a WUS; or
fifth indication information, wherein the fifth indication information is used for indicating monitoring a PDCCH.

8. The method according to claim 7, wherein the second condition comprises at least one of the following:
a first timer is running;
a second timer is running;
a main communication module of the terminal is in a normal state;
a monitoring occasion of a WUS is invalid; or
a WUS is detected in a valid monitoring occasion of a WUS; wherein
the first timer is a timer used for limiting suspension of WUS monitoring after detection of a WUS; and the second timer is a timer used for limiting suspension of WUS monitoring after detection of a PDCCH.

9. The method according to claim 8, wherein the method further comprises:
in a case that a WUS is detected, starting, by the terminal, the first timer at a third time after a time unit in which the WUS is detected.

10. The method according to claim 9, wherein the method further comprises at least one of the following:
in a case that a PDCCH is detected during running of the first timer, starting, by the terminal, a second timer at a fourth time after an end moment of a time unit in which the detected PDCCH is located; or
in a case that a PDCCH is detected during running of the second timer, restarting, by the terminal, the second timer.

11. The method according to claim 8, wherein the second operation satisfies:
in a case that a WUS is detected in the valid monitoring occasion of a WUS, the terminal starts PDCCH monitoring from an N-th time unit after a time unit in which the WUS is detected.

12. The method according to claim 8, wherein the method further comprises:
determining, by the terminal in a case that the following is satisfied, that the monitoring occasion of a WUS is invalid:
the monitoring occasion of a WUS conflicts with a transmission resource of the main communication module of the terminal, wherein the transmission resource comprises at least one of uplink transmission, downlink reception or a guard interval.

13. A transmission processing method, comprising:
transmitting, by a network-side device, first information to a terminal, wherein the first information is used for triggering the terminal to perform a first operation, and the first operation comprises at least one of monitoring a wake-up signal WUS or not monitoring a physical downlink control channel PDCCH; wherein
the first information comprises at least one of the following:
first indication information, wherein the first indication information is used for indicating activation of WUS monitoring; or
second indication information, wherein the second indication information is used for indicating not monitoring a PDCCH.

14. The method according to claim 13, wherein the first indication information comprises a target parameter, wherein the target parameter is used for configuring or updating configuration information of a WUS, and the target parameter comprises at least one of the following:
an activation effective time of WUS monitoring;
a time for stopping PDCCH monitoring;
a monitoring mode of the WUS;
a time-domain resource of the WUS;
a frequency-domain resource of the WUS; or
transmission information of the WUS, wherein the transmission information comprises at least one of whether to perform repetition or the number of repetitions.

15. The method according to claim 14, wherein the activation effective time of WUS monitoring is greater than or equal to at least one of the following:
a processing time of the first information;
a time for the terminal to transmit a hybrid automatic repeat request acknowledgement HARQ-ACK to the network-side device for a demodulation result of the first information; or
a time for a wake-up radio of the terminal to switch from off to on.

16. The method according to claim 13, wherein after the transmitting, by a network-side device, first information to a terminal, the method further comprises:
transmitting, by the network-side device, second information to the terminal, wherein the second information comprises at least one of the following:
fourth indication information, wherein the fourth indication information is used for indicating at least one of deactivating WUS monitoring or clearing configuration information of a WUS; or
fifth indication information, wherein the fifth indication information is used for indicating monitoring a PDCCH.

17. A terminal, comprising a processor and a memory, wherein the memory stores a program or an instruction executable on the processor, and the program or instruction, when executed by the processor, implements a transmission processing method, the method comprising:
performing, by a terminal, a first operation according to at least one of first information or a first condition, wherein the first operation comprises at least one of monitoring a wake-up signal (WUS) or not monitoring a physical downlink control channel (PDCCH); wherein
the first condition is a condition for the terminal to enable WUS monitoring; and the first information comprises at least one of the following:
first indication information, wherein the first indication information is used for indicating activation of WUS monitoring; or
second indication information, wherein the second indication information is used for indicating not monitoring a PDCCH.

18. A network-side device, comprising a processor and a memory, wherein the memory stores a program or an instruction executable on the processor, and the program or an instruction, when executed by the processor, implements the transmission processing method according to claim 13.

19. A non-transitory readable storage medium, wherein a program or an instruction is stored on the readable storage medium, and the program or instruction, when executed by a processor, implements the transmission processing method according to claim 1.

20. A non-transitory readable storage medium, wherein a program or an instruction is stored on the readable storage medium, and the program or instruction, when executed by a processor, implements the transmission processing method according to claim 13.
